(19) United States
(12) Patent Application Publication
(10) Pub. No.: US 2016/0215133 A1
(43) Pub. Date: Jul. 28, 2016

(54) METHOD FOR PREPARING A CROSSLINKED FLUORINATED POLYMER COMPOSITION

(71) Applicant: ARKEMA FRANCE, Colombes (FR)

(72) Inventors: Anthony BONNET, Saint Laurent De Mure (FR); Cyrille MATHIEU, Lyon (FR); Barbara RAMFEL, Barc (FR); Alejandra REYNA-VALENCIA, Evreux (FR)

(21) Appl. No.: 14/915,940

(22) PCT Filed: Sep. 2, 2014
(86) PCT No.: PCT/FR2014/052162

§ 371 Date: Mar. 2, 2016

(30) Foreign Application Priority Data
Sep. 2, 2013 (FR) 1358388

(51) Int. Cl. C08L 27/16; F16L 11/04; C08J 3/24; C08J 3/00; C08J 3/28

(52) U.S. Cl. CPC C08L 27/16; C08J 3/005; C08J 3/28; C08J 3/24; F16L 11/04; C08J 2327/16; C08J 2427/16; C08L 2205/025; C08L 2312/06; C08L 2203/18; C08L 2203/202

(57) ABSTRACT

The invention relates to a method for producing composition, said method involving—mixing a polyvinylidene fluoride with a copolymer of vinylidene fluoride and a comonomer, and with a crosslinking agent; crosslinking the obtained mixture. The invention further relates to the composition obtained by said method as well as the use of the composition for producing various items, such as pipes.”

### FIELD OF THE INVENTION

The present invention relates to a process for the preparation of a composition of crosslinked fluoropolymers, and also to the composition thus obtained, and to the use of this composition in the manufacture of various articles, in particular the polymeric sheaths of the flexible pipes used for the transportation of fluids of oil (off-shore and on-shore) or gas operations.

### TECHNICAL BACKGROUND

The polyvinylidene fluoride (PVDF) is a widely used thermoplastic polymer, for example in the chemical industry and in oil extraction, as a result of its high qualities and performance in terms of chemical resistance, mechanical properties and maximum operating temperature. However, under extreme operating conditions, it can exhibit a lack of flexibility and/or an excessively high brittleness temperature.

It is known to modify the PVDF chain, consisting of vinylidene fluoride (VDF or VF₂) units, with an olefin which can be copolymerized with the vinylidene fluoride, which confers, on the resulting copolymer, improved properties of flexibility and/or of mechanical properties under cold conditions. Numerous comonomers have been proposed to date, in particular hexafluoropropene (HFP).

It is also known to combine several fluoropolymers together in order to obtain a composition exhibiting optimized properties.

It is also known to crosslink PVDFs or derivatives by irradiation.

For example, the document U.S. Pat. No. 3,580,829 describes a composition comprising PVDF and a compatible polyfunctional monomer, which composition is treated by irradiation in order to bring about crosslinking of the PVDF.

The document WO 99/25747 describes compositions containing PVDF or VDF-based copolymers, mixed with a compound carrying maleimide and/or nadimide functional groups. The crosslinking is obtained by heating the composition.

The document U.S. Pat. No. 6,156,847 describes a composition comprising a copolymer of VDF and chlorotrifluoroethylene (CTFE) and a crosslinking agent, and also the crosslinking of this composition.

The document US 2001/0023776 describes the use of a copolymer obtained by polymerization of a first monomer comprising at least 95% of VDF, followed by addition to the reaction medium of a second monomer comprising VDF and a comonomer. This copolymer is used to provide insulation of wires. It can be crosslinked by irradiation and, for this purpose, be combined with a crosslinking agent, such as triallyl isocyanurate or triallyl cyanurate.

The document EP 1 433 813 describes a composition of heterogeneous PVDF (for example containing HFP monomers) and aromatic bisamide, and the crosslinking of this composition by irradiation.

The document EP 1484346 describes a process for grafting an unsaturated monomer to a fluoropolymer of the PVDF type by melt blending the two components, shaping and irradiating.

There also exists a need to provide compositions of fluorinated thermoplastic polymers exhibiting an improved creep strength, in particular at a temperature greater than the melting point of the PVDF, combined with a good low-temperature fatigue strength.

There also still exists a need to provide compositions of fluorinated thermoplastic polymers exhibiting improved properties for the manufacture of umbilicals and flexible pipes used in particular in off-shore operations.

### SUMMARY OF THE INVENTION

The invention relates first to a process for the manufacture of a composition, comprising the following stages:
the blending of a polyvinylidene fluoride with a copolymer of vinylidene fluoride and a comonomer and with a crosslinking agent;
the crosslinking of the blend obtained.

According to one embodiment, the process additionally comprises the extrusion of the blend before it is crosslinked; or the coextrusion of the blend with at least one secondary composition before the crosslinking, the secondary composition preferably being coextruded in the internal position with respect to said blend.

According to one embodiment, the crosslinking is obtained by irradiation of the blend.

The stage of producing said blend of the homopolymer, the copolymer and the crosslinking agent is carried out by means of any method which makes it possible to obtain a homogeneous blend of these constituents. Mention may in particular be made, among these methods, of melt blending or dry blending.

More particularly, the composition according to the invention is prepared by melt blending all the constituents on a compounding device, such as a twin-screw extruder, a co-kneader, an internal mixer or an open mill.

According to one embodiment, the homopolymer and the copolymer are in the dry form during the blending, preferably in the form of powders, and the blending with the crosslinking agent and optionally with the plasticizer is preferably carried out in the molten state on a compounding device, such as a twin-screw extruder, a co-kneader, an internal mixer or an open mill.

According to one embodiment, the above process comprises the blending of the homopolymer and the copolymer in the latex form, the drying of the blend of homopolymer and copolymer, and the combining of the dried blend with the crosslinking agent and optionally with the plasticizer is carried out in the molten state on a compounding device, such as a twin-screw extruder, a co-kneader, an internal mixer or an open mill.

The composition according to the invention obtained by the manufacturing process described above can subsequently be transformed for use in the form of pipes or cables, in particular using devices such as an extruder equipped with an appropriate die, or else for use as binders for conductive particles.

According to one embodiment, the composition additionally comprises a plasticizer, preferably in a proportion by weight of 0.5 to 7%, more preferably of 1 to 5%, more preferably still of 2 to 4%, advantageously of 1.5 to 3.5%, the plasticizer preferably being chosen from dibutyl sehacate, dioctyl phthalate, N-(n-butyl)sulforiamide, polymeric polyesters and the combinations of these, and more preferably being dibutyl sebarate.

According to one embodiment, in the composition prepared according to the process of the invention:
the proportion by weight of the polyvinylidene fluoride in the blend is from 65 to 85%, preferably from 70 to 80%; and/or
the proportion by weight of the copolymer in the blend is from 10 to 30%, preferably from 15 to 25%; and/or
rthe proportion by weight of crosslinking agent is from 0.1 to 10%, preferably from 2 to 6%,
   the total coming to 100%.

According to one embodiment, the comonomer present in the copolymer is chosen from hexafluoropropylene, chlorotrifluoroethylene, tetrafluoroethylene, trifluoroethylene, chlorofluoroethylene and the combinations of these, and is preferably hexafluoropropene.

According to one embodiment, the comonomer is present in the copolymer in a proportion by weight of 20 to 40%, preferably of 20 to 35%, more preferably of 20 to 30%, more preferably still of 20 to 25%, advantageously of 20 to 24%.

According to one embodiment, the crosslinking agent is chosen from hisimides, triallyl eyanurate and triallyl isocyanurate.

The invention also relates to a composition capable of being obtained by the process described above.

The invention also relates to a process for the manufacture of an article comprising the manufacture of a composition according to the process described above and the shaping of the composition.

According to one embodiment, the article is a pipe for the transportation of products in the gas or liquid state or a portion of such a pipe, such as a layer of this pipe.

According to one embodiment, the pipe is a pipe for the transportation of synthesis products, in particular for the transportation of hydrogen, oxygen, steam, carbon monoxide, ammonia, hydrogen fluoride, hydrochloric acid, hydrogen sulfide, any gas resulting from the cracking of hydrocarbons, or mixtures of these.

According to one embodiment, the pipe is a pipe for the transportation of water, solvents or mixtures of these.

According to one embodiment, the pipe is an underground pipe for a service station or a fuel feed pipe for vehicles.

According to one embodiment, the pipe is an umbilical or flexible pipe for the transportation of crude oil, natural gas, water and/or other drilling products.

According to one embodiment, the pipe is a pipe for off-shore use.

According to one embodiment, the article is an electric cable or a portion of such an electric cable, such as a layer of this cable.

The invention also relates to an article capable of being obtained according to the abovementioned process.

The present invention makes it possible to overcome the disadvantages of the state of the art. It more particularly provides a process which makes it possible to manufacture compositions of fluorinated thermoplastic polymers exhibiting an improved creep strength, in particular at a temperature greater than the melting point of the PVDF, in combination with a good low-temperature fatigue strength (fatigue at a temperature of less than 0° C.).

These compositions exhibit improved properties for the manufacture of umbilicals and flexible pipes used in particular in off-shore operations.

This is accomplished by virtue of the provision of a blend of PVDF and VDF-based copolymer particular P(VDF-HFP) copolymer and in particular P(VDF-HFP) copolymer with a relatively high content of HFP), in combination with a crosslinking agent.

The compositions of fluorinated thermoplastic polymers obtained according to the invention exhibit an excellent morphological stability as a result of the preferential crosslinking of the copolymer.

The invention offers a noteworthy flexibility in the production of compositions of thermoplastic fluoropolymers exhibiting the desired properties. This is because the presence of the copolymer makes it possible to confer the desired cold fatigue strength. In this regard, it is preferable to use a copolymer having a relatively high viscosity. In point of fact, the invention makes it possible to choose the viscosity of the copolymer independently of the viscosity of the PVDF this latter viscosity having to remain sufficiently low to be able to correctly process the composition and in particular to be able to correctly extrude it.

The heterogeneous PVDFs which are described in the documents EP 1 433 813 and US 2001/0023776 do not make it possible to adjust the viscosity of the PVDF independently of that of the copolymer since they are obtained by a single polymerization.

### DESCRIPTION OF EMBODIMENTS OF THE INVENTION

The invention is now described in more detail and without limitation in the description which follows.

Unless otherwise mentioned, all the percentages shown correspond to proportions by weight.

The composition according to the invention is a composition manufactured from a PVDF polymer, a VDF-based copolymer and a crosslinking agent.

The PVDF polymer used in the context of the invention preferably exhibits a melt flow index of less than or equal to 15 g/10 min, advantageously of less than or equal to 10 g/10 min and ideally of less than or equal to 5 g/10 mm, according to the standard ISO 1133 (230° C., 12.5 kg), in order to guarantee good mechanical strength properties.

The proportion by weight of this PVDF present in the blend making it possible to manufacture the composition can, for example, be from 65 to 67%; or from 67 to 69%; or from 69 to 71%; or from 71 to 73%; or from 73 to 75%; or from 75 to 77%; or from 77 to 79%; or from 79 to 81%; or from 81 to 83%; or from 83 to 85%.

The copolymer used in the context of the invention is a copolymer of vinylidene fluoride and a comonomer. Preferably, it is a fluorinated comonomer. Said copolymer is a random copolymer.

According to one embodiment, the fluorinated comonomer is chosen from vinyl fluoride, trifluoroethylene, chlorotrifluoroethylene (CTFE), 1,2-difluoroethylene, tetrafluoroethylene (TFE), hexafluoropropylene (HFP), perfluoro(alkyl vinyl) ethers, such as perfluoro(methyl vinyl) ether (MVP, perfluoro(ethyl vinyl) ether (PEVE) or perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₇OCN or CH₂OPO₃H, the product of formula CF₂═CFOCF₂CF₂SO₂F; the product of formula F(CF₂)ₙCH₂OCF═CF₂ in which n is 1, 2, 3, 4 or 5; the product of formula R1CH₂OCF═CF₂ in which R1 is hydrogen or F(CF₂)_{z} and z has the value 1, 2, 3 or 4; the product of formula R3OCF═CH₂ in which R3 is F(CF₂)_{z} and z has the value 1, 2, 3 or 4; or also perfluorobutylethylene (PFBE), fluorinated ethylene propylene (FEP), 3,3,3-trifluoropropene, 2-trifluoromethyl-3,3,3-trifluoro-1-propene, 2,3,3,3 -tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234ye, 1,2,3,3-tetrafluoropropene or HFO-1234ye, 1,1,3,3-tetrafluoropropene or HFO-1234zc, and chlorotetrafluoropropene or HCFO-1224.

Use may be made of combinations of several of these comonomers. For example, if two different comonomers are used, the copolymer is in reality a terpolymer (the proportion by weight of comonomer mentioned in the patent application then being understood as representing the proportion by weight of the sum of the comonomers).

Preferably, just one comonomer is present in the copolymer.

Furthermore, it is also possible to use a blend of two or more than two of the above copolymers, for example a blend of P(VDF-1-HFP) and P(VDF-CTFE). In such a case, all the instructions relating to the proportion of copolymer in the blend making it possible to manufacture the composition are read as referring to the proportion of the combined copolymers in the blend.

However, it is preferred for just one copolymer to be present.

According to one embodiment, the comonomer is chosen from the HFP, CTFE, CFE, TFE and TrFE.

Preferably, it is HFP: it is this example which is selected for the continuation of the description, it being understood that the latter is similarly valid when HFP is replaced with another comonomer.

The P(VDF-1-HFP) copolymer is obtained by copolymerization of VDF monomers and HFP monomers.

According to embodiments, the proportion by weight of HFP comonomer in the copolymer is from 20 to 21%; or from 21 to 22%; or from 22 to 23%; or from 23 to 24%; or from 24 to 25%; or from 25 to 26%; or from 26 to 27%; or from 27 to 28%; or from 28 to 29%; or from 29 to 30%; or from 30 to 31%; or from 31 to 32%; or from 32 to 33%; or from 33 to 34%; or from 34 to 35%; or from 35 to 36%; or from 36 to 37%; or from 37 to 38%; or from 38 to 39%; or from 39 to 40%.

The proportion by weight of fluorinated comonomer in the copolymer is preferably determined by nuclear magnetic resonance. Use may in particular be made of the following ¹⁹F NMR method developed for a VDF/HFP copolymer. The copolymer samples are dissolved in an NMR tube with a diameter of 5 mm. The copolymer samples containing more than 10% by weight of HFP are dissolved in d₆-acetone at 55° C. An amount of copolymer (approximately 10 mg) is placed in a tube and solvent is added to fill 5.5 cm of tube (approximately 0.75 ml of solvent). A heating plate is used to bring the samples to the desired temperature. The samples are heated for at least one hour until the solid has dissolved and the gel has disappeared. The tubes are inverted in order to confirm the absence of gel.

The spectra are acquired on a spectrometer of Bruker DMX or Varian Mercury 300 type operated at 55° C. in the case of the solvent d₆-acetone and are analyzed according to the method described in “Composition and sequence distribution of vinylidene fluoride copolymer and terpolymer fluoroelastomers. Determination by ¹⁹F NMR spectroscopy and correlation with some properties”, M. Pianca et al., Polymer, 1987, vol. 28, 224-230. The accuracy of the measurements is confirmed by measuring the integrals of CF₃ and CF and by comparing them in order to see if they are indeed in a ratio of 3 to 1.

Preferably, the copolymer used for the preparation of the composition according to the invention is essentially devoid of homopolymer.

The copolymer can in particular be manufactured according to the method described in the patent EP 1 144 469 B1.

The proportion by weight of the above copolymer (and in particular of P(VDF-HFP)) in the blend making it possible to manufacture the composition can, for example, be from 10 to 12%; or from 12 to 14%; or from 14 to 16%; or from 16 to 18%; or from 18 to 20%; or from 20 to 22%; or from 22 to 24%; or from 24 to 26%; or from 26 to 28%; or from 28 to 30%.

The crosslinking agent can be a (aromatic or nonaromatic) bisimide, in particular a bismaleimide or a bisnadimide.

Aromatic bisimides can be defined as the reaction products of two moles of unsaturated dicarboxylic acid anhydride with an aromatic diamine. Advantageously, these are the products of following formulae (1) and (2):

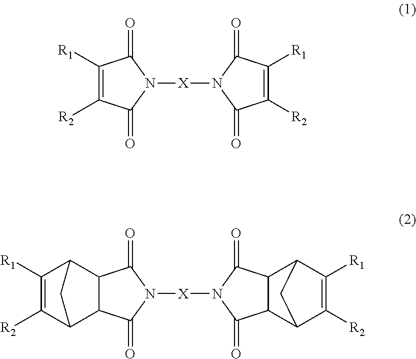

in which R₁ and R₂ mean, independently of one another, hydrogen or a linear or branched C₁-C₂₄ alkyl residue or a C₅-C₁₂ cycloalkyl, C₆-C₂₄ aryl, C₄-C₂₄heteroaryl, C₇-C₂₄ aralkyl or C₇-C₂₄ alkaryl residue;

in particular hydrogen or a linear or branched C₁-C₁₈ alkyl residue or a C₅-C₈ cycloalkyl, C₆-C₁₈ aryl, C₄-C₁₈ heteroaryl, C₇-C₁₈ aralkyl or C₇-C₁₈ alkaryl residue;

preferably hydrogen or a linear or branched C₁-C₁₂ alkyl residue or a C₅-C₈ cycloalkyl, C₆-C₁₈ aryl, C₇-C₁₈ aralkyl or C₇-C₁₂ alkylaryl residue;

in particular hydrogen or a linear or branched C₁-C₁₂ alkyl residue or a cyclohexyl, phenyl, biphenyl, C₇-C₁₂ aralkyl or C₇-C₁₂ alkaryl residue;

in which X means a C₆-C₂₄ arylene, C₄-C₂₄ heteroarylene, C₇-C₂₄ aralkylene or C₇-C₂₄ alkarylene residue;

in particular a C₆-C₁₈ arylene, C₄-C₂₈ heteroarylene, C₇-C₁₈ aralkylene or C₇-C₁₈ alkarylene residue;

preferably a C₆-C₁₈ arylene, C₄-C₁₂ heteroarylene, C₇-C₁₈ aralkylene or C₇-C₁₈ alkarylene residue;

in particular a phenylene, biphenylene, C₇-C₁₂ aralkylene or C₇-C₁₂ alkarylene residue.

Advantageously, X is a residue resulting from an aromatic diamine and corresponds to the following formula (3):

Preferably, the bisimide is methylenedianiline bismaleimide (MDA-BMI) or N,N′-m-phenylene bismaleimide.

Alternatively, the bisimide can be nonaromatic, in which case X can denote a linear or branched C₁-C₂₄ alkylene residue or a C₅-C₁₂ cycloalkylene residue; in particular a linear or branched C₁-C₁₈ alkylene residue or a C₅-C₈ cycloalkylene residue; preferably a linear or branched C₁-C₁₂ alkylene residue or a C₅-C₈ cycloalkylene residue; in particular a linear or branched C₁-C₈ alkylene residue.

For example, the bisimide can be N,N′-ethylene bismaleimide.

The bisimide compounds can be manufactured as indicated in the document EP

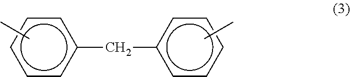

433 813 or the document WO 99/25747.

Alternatively, use may be made of other crosslinking agents, such as triallyl cyanurate (TAC) and triallyl isocyanurate (TAIC), allyl esters of polycarboxylic acids, such as diallyl phthalate and tetraalkyl pyromellitate, multiacrylates, such as dipentaerythritol hexamethacrylate, trivinyl cyanurate, trivinyl citrate, pentaerythritol tetravinyl ether or N,N′-ethylenebisacrylamide. Triallyl cyanurate and triallyl isocyanurate are preferred.

More generally, the crosslinking agent can be chosen from aliphatic, cycloaliphatic, arylaliphatic, heteroaromatic or aromatic amine or polyamine compounds, olefinic or polyolefinic compounds, in particular bisdienes, bisallylphenols or bisvinylberizenes, acetylenic or polyacetylenic compounds, epoxide or polyepoxide compounds, or compounds of cyanate or polycyan ate type.

The proportion by weight of crosslinking agent in the blend can, for example, be from 0.1 to 0.5%; or from 0.5 to 1%; or from 1 to 2%; or from 2 to 3%; or from 3 to 4%; or from 4 to 5%; or from 5 to 6%; or from 6 to 7%; or from 7 to 8%; or from 8 to 9%; or from 9 to 10%.

Optionally, a plasticizer can be added to the blend making it possible to manufacture the composition according to the invention.

Plasticizers within the meaning of the invention are compounds defined in the work Encyclopedia of Polymer Science and Engineering, published by Wiley & Sons (1989), pp. 568-569 and pp. 588-593. They can be monomeric or polymeric. Mention may in particular be made of dibutyl sebacate, dioctyl phthalate, N-(n-butyl)sulfonamide, polymeric polyesters and the combinations of these. The appropriate polymeric polyesters are in particular those derived from adipic acid, azelaic acid or sebacic acid and diols, and the combinations of these, the molecular weight preferably being greater than or equal to 1500, more particularly greater than or equal to 1800, and preferably less than or equal to 5000 and more particularly less than or equal to 2500. Plasticizers with an excessive molecular weight would result in a composition exhibiting an excessively low impact strength.

Dibutyl sebacate constitutes a particularly advantageous plasticizer.

Use may also be made, as plasticizer, of PVDF or a PVDF-derived copolymer (for example P(VDF-HFP)) exhibiting a lower viscosity than the PVDF and the P(VDF-HFP) which are described above, which represent the two main constituents of the blend making it possible to manufacture the composition. This plasticizing PVDF or copolymer can thus have a viscosity, under 100 s⁻¹ and to at a temperature of 230° C., which is lower than the viscosity of the predominant PVDF by a factor at least equal to 5, or at least equal to 10, or at least equal to 20, or at least equal to 30. For example, this plasticizing PVDF or copolymer can have a viscosity of 50 to 1000 Pa·s, preferably from 50 to 300 Pa·s, under 100 s⁻¹ and at a temperature of 230° C.

The presence of the plasticizer facilitates the manufacture of the composition according to the invention or its transformation in order to manufacture various products or articles. It also improves the impact strength of the composition according to the invention.

The plasticizer can be present in the blend in a proportion by weight of 0.1 to 5%; and in particular: of 0.1 to 1%; or of 1 to 2%; or of 2 to 3%; or of 3 to 4%; or of 4 to 5%.

According to one embodiment, the blend is devoid of plasticizer. It should be noted that the crosslinking agent can itself have a plasticizing effect, which can limit or prevent recourse to a plasticizer as such.

According to one embodiment, the blend used in the invention consists of PVDF, P(VDF-HFP) and the crosslinking agent.

According to one embodiment, the blend used in the invention consists of PVDF, P(VDF-HFP), the crosslinking agent and the plasticizer.

According to one embodiment, the blend used in the invention consists of PVDF, the VDF copolymer, which can in particular be P(VDF-HFP), the crosslinking agent, the plasticizer and one or more additives.

The additives comprise, for example, fibers, a manufacturing additive and/or a stabilizer.

The fibers can be chosen from polymeric fibers, for example polyamide, polyamide/polyether block copolymer (sold under the name Pebax®), high-density polyethylene, polypropylene or polyester fibers, for example polyhydroxyalkanoates and polyesters (sold by DuPont under the Hytrel® trade name), or also crosslinked PVDF fibers. The latter can be obtained by extrusion of PVDF, followed by irradiation in order to bring about the crosslinking. A crosslinking agent (as described in the present patent application) can be added in order to promote this crosslinking.

The use of crosslinked PVDF fibers exhibits the advantage of good compatibility between the fibers and the polymer matrix. In that way, good tying of the fibers in the matrix is obtained, damage to the matrix by the fibers is avoided and a saving in weight, in comparison, for example, with glass fibers, is obtained.

Other fibers which can be used are carbon fibers, glass fibers, in particular of R or S2 type, aramid (trade name Kevlare) fibers, boron fibers, silica fibers, natural fibers, such as flax, hemp or sisal, carbon nanotubes and carbon nanofibers.

For all of the above fibers, the mean diameter is advantageously from 2 to 100 μm, preferably from 10 to 20 μm, and the mean length is advantageously from 0.5 to 10 mm, preferably from 2 to 4 mm. These are means by number, or with the whole of the fibers.

The carbon nanotubes and carbon nanofibers exhibits a mean diameter ranging from 0.4 to 100 nm, preferably from 1 to 50 nm and better still from 2 to 30 nm, indeed even from 10 to 15 nm, and advantageously a length of 0.1 to 10 μm.

Use may also be made of mixtures of two or more than two types of above fibers.

The proportion of fibers in the composition can, for example, be from 0 to 1%; or from 1 to 2%; or from 2 to 3%; or from 3 to 4%; or from 4 to 5%.

The manufacturing additive can be a lubricant. Mention may in particular be made of stearates, such as calcium stearate or zinc stearate, natural waxes and polytetrafluoroethylene and its derivatives. When a manufacturing additive is present, it is typically included in a proportion by weight of 0.01 to 0.3%, preferably from 0.02 to 0.1%.

A stabilizer can also be included, in particular in order to capture the compounds emitted during the crosslinking, such as HF and/or HCl. Use may be made, for example, of zinc oxide.

When a stabilizer is present, it is typically included in a proportion by weight of 0.5 to 3%.

Preferably, the combined additives mentioned above are present in the blend in a proportion by weight of less than or equal to 10%, or of less than or equal to 9%, or of less than or equal to 8%, or of less than or equal to 7%, or of less than or equal to 6%, or of less than or equal to 5%, or of less than or equal to 4%, or of less than or equal to 3%, or of less than or equal 2%, or of less than or equal 1%.

Examples of formulations for the blend making it possible to manufacture the composition according to the invention appear in the table below (the amount of crosslinking agent and of additives not being specified):

| | Proportion | Proportion of | Proportion of HFP in |
|---|---|---|---|
| Formulation No. | of PVDF | P(VDF-HFP) | the P(VDF-HFP) |
| 1 | 65 to 69% | 10 to 14% | 20 to 24% |
| 2 | 65 to 69% | 10 to 14% | 24 to 28% |
| 3 | 65 to 69% | 10 to 14% | 28 to 32% |
| 4 | 65 to 69% | 10 to 14% | 32 to 36% |
| 5 | 65 to 69% | 10 to 14% | 36 to 40% |
| 6 | 65 to 69% | 14 to 18% | 20 to 24% |
| 7 | 65 to 69% | 14 to 18% | 24 to 28% |
| 8 | 65 to 69% | 14 to 18% | 28 to 32% |
| 9 | 65 to 69% | 14 to 18% | 32 to 36% |
| 10 | 65 to 69% | 14 to 18% | 36 to 40% |
| 11 | 65 to 69% | 18 to 22% | 20 to 24% |
| 12 | 65 to 69% | 18 to 22% | 24 to 28% |
| 13 | 65 to 69% | 18 to 22% | 28 to 32% |
| 14 | 65 to 69% | 18 to 22% | 32 to 36% |
| 15 | 65 to 69% | 18 to 22% | 36 to 40% |
| 16 | 65 to 69% | 22 to 26% | 20 to 24% |
| 17 | 65 to 69% | 22 to 26% | 24 to 28% |
| 18 | 65 to 69% | 22 to 26% | 28 to 32% |
| 19 | 65 to 69% | 22 to 26% | 32 to 36% |
| 20 | 65 to 69% | 22 to 26% | 36 to 40% |
| 21 | 65 to 69% | 26 to 30% | 20 to 24% |
| 22 | 65 to 69% | 26 to 30% | 24 to 28% |
| 23 | 65 to 69% | 26 to 30% | 28 to 32% |
| 24 | 65 to 69% | 26 to 30% | 32 to 36% |
| 25 | 65 to 69% | 26 to 30% | 36 to 40% |
| 26 | 69 to 73% | 10 to 14% | 20 to 24% |
| 27 | 69 to 73% | 10 to 14% | 24 to 28% |
| 28 | 69 to 73% | 10 to 14% | 28 to 32% |
| 29 | 69 to 73% | 10 to 14% | 32 to 36% |
| 30 | 69 to 73% | 10 to 14% | 36 to 40% |
| 31 | 69 to 73% | 14 to 18% | 20 to 24% |
| 32 | 69 to 73% | 14 to 18% | 24 to 28% |
| 33 | 69 to 73% | 14 to 18% | 28 to 32% |
| 34 | 69 to 73% | 14 to 18% | 32 to 36% |
| 35 | 69 to 73% | 14 to 18% | 36 to 40% |
| 36 | 69 to 73% | 18 to 22% | 20 to 24% |
| 37 | 69 to 73% | 18 to 22% | 24 to 28% |
| 38 | 69 to 73% | 18 to 22% | 28 to 32% |
| 39 | 69 to 73% | 18 to 22% | 32 to 36% |
| 40 | 69 to 73% | 18 to 22% | 36 to 40% |
| 41 | 69 to 73% | 22 to 26% | 20 to 24% |
| 42 | 69 to 73% | 22 to 26% | 24 to 28% |
| 43 | 69 to 73% | 22 to 26% | 28 to 32% |
| 44 | 69 to 73% | 22 to 26% | 32 to 36% |
| 45 | 69 to 73% | 22 to 26% | 36 to 40% |
| 46 | 69 to 73% | 26 to 30% | 20 to 24% |
| 47 | 69 to 73% | 26 to 30% | 24 to 28% |
| 48 | 69 to 73% | 26 to 30% | 28 to 32% |
| 49 | 69 to 73% | 26 to 30% | 32 to 36% |
| 50 | 69 to 73% | 26 to 30% | 36 to 40% |
| 51 | 73 to 77% | 10 to 14% | 20 to 24% |
| 52 | 73 to 77% | 10 to 14% | 24 to 28% |
| 53 | 73 to 77% | 10 to 14% | 28 to 32% |
| 54 | 73 to 77% | 10 to 14% | 32 to 36% |
| 55 | 73 to 77% | 10 to 14% | 36 to 40% |
| 56 | 73 to 77% | 14 to 18% | 20 to 24% |
| 57 | 73 to 77% | 14 to 18% | 24 to 28% |
| 58 | 73 to 77% | 14 to 18% | 28 to 32% |
| 59 | 73 to 77% | 14 to 18% | 32 to 36% |
| 60 | 73 to 77% | 14 to 18% | 36 to 40% |
| 61 | 73 to 77% | 18 to 22% | 20 to 24% |
| 62 | 73 to 77% | 18 to 22% | 24 to 28% |
| 63 | 73 to 77% | 18 to 22% | 28 to 32% |
| 64 | 73 to 77% | 18 to 22% | 32 to 36% |
| 65 | 73 to 77% | 18 to 22% | 36 to 40% |
| 66 | 73 to 77% | 22 to 26% | 20 to 24% |
| 67 | 73 to 77% | 22 to 26% | 24 to 28% |
| 68 | 73 to 77% | 22 to 26% | 28 to 32% |
| 69 | 73 to 77% | 22 to 26% | 32 to 36% |
| 70 | 73 to 77% | 22 to 26% | 36 to 40% |
| 71 | 77 to 81% | 10 to 14% | 20 to 24% |
| 72 | 77 to 81% | 10 to 14% | 24 to 28% |
| 73 | 77 to 81% | 10 to 14% | 28 to 32% |
| 74 | 77 to 81% | 10 to 14% | 32 to 36% |
| 75 | 77 to 81% | 10 to 14% | 36 to 40% |
| 76 | 77 to 81% | 14 to 18% | 20 to 24% |
| 78 | 77 to 81% | 14 to 18% | 24 to 28% |
| 79 | 77 to 81% | 14 to 18% | 28 to 32% |
| 80 | 77 to 81% | 14 to 18% | 32 to 36% |
| 81 | 77 to 81% | 14 to 18% | 36 to 40% |
| 82 | 77 to 81% | 18 to 22% | 20 to 24% |
| 83 | 77 to 81% | 18 to 22% | 24 to 28% |
| 84 | 77 to 81% | 18 to 22% | 28 to 32% |
| 85 | 77 to 81% | 18 to 22% | 32 to 36% |
| 86 | 77 to 81% | 18 to 22% | 36 to 40% |
| 87 | 81 to 85% | 10 to 14% | 20 to 24% |
| 88 | 81 to 85% | 10 to 14% | 24 to 28% |
| 89 | 81 to 85% | 10 to 14% | 28 to 32% |
| 90 | 81 to 85% | 10 to 14% | 32 to 36% |
| 91 | 81 to 85% | 10 to 14% | 36 to 40% |
| 92 | 81 to 85% | 14 to 18% | 20 to 24% |
| 93 | 81 to 85% | 14 to 18% | 24 to 28% |
| 94 | 81 to 85% | 14 to 18% | 28 to 32% |
| 95 | 81 to 85% | 14 to 18% | 32 to 36% |
| 96 | 81 to 85% | 14 to 18% | 36 to 40% |

According to one embodiment, for each of the formulations 1 to 96 above, the proportion by weight of crosslinking agent in the blend has a value from 0.1 to 1%.

According to one embodiment, for each of the formulations 1 to 96 above, the proportion by weight of crosslinking agent in the blend has a value from 1 to 2%.

According to one embodiment, for each of the formulations 1 to 96 above, the proportion by weight of crosslinking agent in the blend has a value from 2 to 4%.

According to one embodiment, for each of the formulations 1 to 96 above, the proportion by weight of crosslinking agent in the blend has a value from 4 to 6%.

According to one embodiment, for each of the formulations 1 to 96 above, the proportion by weight of crosslinking agent in the blend has a value from 6 to 8%.

According to one embodiment, for each of the formulations 1 to 96 above, the proportion by weight of crosslinking agent in the blend has a value from 8 to 10%.

According to one embodiment, for each of the formulations 1 to 96 above, the HFP comonomer can be replaced by the CITE comonomer.

According to one embodiment, for each of the formulations 1 to 96 above, the HFP comonomer can be replaced by the TFE comonomer.

According to one embodiment, for each of the formulations 1 to 96 above, the HFP comonomer can be replaced by the TrFE comonomer.

According to one embodiment, for each of the formulations 1 to 96 above, the HFP comonomer can be replaced by the CFE comonomer.

The process of the invention provides for the manufacture of the composition according to the invention by melt blending PVDF and P(VDF-HFP) (starting from powders or granules) in an extruder, an open mill or any other type of appropriate device.

The crosslinking agent, optionally the plasticizer and, if appropriate, the optional additives can be incorporated during the blending of the PVDF and the P(VDF-HFP), or also be blended with one or other of these constituents prior to the blending thereof, or also subsequent to the blending of the PVDF and the P(VDF-HFP), or also be introduced in the form of a masterbatch contributing a portion of one of the two constituents (PVDF or P(VDF-HFP)), according to the blending techniques set out above.

Once all the compounds have been blended, the blend is crosslinked. This crosslinking preferably occurs after extrusion of the blend.

The crosslinking is carried out by irradiation, that is to say exposure to ionizing radiation with a sufficient intensity and a sufficient duration to bring about the crosslinking. Use is generally made of beta (electron beam) or gamma radiation. The irradiation dose can, for example, be from 10 to 100 kGy.

The reactions deployed by the ionizing radiation depend on the irradiation dose applied to the composition.

The crosslinking of the blend preferably comprises the crosslinking of the crosslinking agent with the fluoropolymers, thus forming an overall three-dimensional network.

The composition according to the invention makes it possible to manufacture umbilicals and flexible pipes used onshore and off-shore (in a marine environment) in order to contain and/or transport crude oil, natural gas, water and other gases used for drilling, as defined in the standards API 17J, API 16C and API 15RS.

The composition according to the invention also makes it possible to manufacture any type of pipe for the transportation of gas or liquid products, intended in particular to transport gas products for the synthesis of chemicals or intended to transport products for individual, industrial or public consumption.

The composition according to the invention also makes it possible to manufacture, alone or in combination with other products, cables, hollow bodies or binders for rechargeable batteries.

The composition according to the invention can be employed in the form of a layer in a multilayer structure or it can be used to form a part in full.

Another subject matter of the invention is, generally, a pipe comprising at least one layer consisting of the composition according to the invention.

According to one embodiment, said pipe is intended to be employed as polymeric sheath of the flexible pipes used for the transportation of fluids of oil and gas operations. In this form, it can be used, in combination with at least one reinforcing layer and an external protective sheath, as flexible pipes for the transportation of fluids of oil or gas operations.

According to one embodiment, said pipe is a pipe for the overland transportation of products in the gas state.

According to one embodiment, the abovementioned pipe is for the transportation of synthesis products, in particular for the transportation of hydrogen, oxygen, steam, carbon monoxide, ammonia, hydrogen fluoride, hydrochloric acid, hydrogen sulfide, any gas resulting from the cracking of hydrocarbons, or mixtures of these.

According to one embodiment, said pipe is intended for the overland transportation of products in the liquid state, for example the transportation of water, solvents or mixtures of these.

According to one embodiment, the abovementioned pipe is an underground pipe for a service station or a fuel feed pipe for vehicles.

Another subject matter of the invention is an electric cable manufactured from the abovementioned composition.

Another subject matter of the invention is a binder for conductive particles for a rechargeable battery, manufactured from the abovementioned composition.

Another subject matter of the invention is the use of the composition described above in the manufacture of pipes, electric cables or binders for conductive particles mentioned above.

The manufacture of the above articles is preferably carried out by extrusion, the composition being formed directly during the extrusion, with subsequent irradiation making the crosslinking possible.

It is also possible to produce the composition by coextrusion with another composition. In this case, the composition according to the invention is preferably arranged externally (in order to facilitate the irradiation).

The composition according to the invention can be tested by means of the fatigue test, which is described in the document WO 2010/026356. It consists in determining, for a given sample of polymeric composition, the number of cycles to failure (denoted NCF), that is to say the number of cycles at the end of which failure of the sample occurs. The higher the NCF value, the better the result of the fatigue test.

In order to carry out a fatigue test, axisymmetric test specimens are cut out from the thickness of an extruded pipe or an extruded strip, with a notch radius of curvature of 4 mm and a minimum radius of 2 mm. These test specimens are regarded as being representative of the local geometry of a pipe used in the applications targeted. The test is carried out by means of a servo-hydraulic testing machine, for example of MTS 810 type. The distance between the jaws is 10 mm. A maximum elongation of 1.4 mm and a ratio of the minimum elongation to the maximum elongation of 0.21, which corresponds to a minimum elongation of 0.3 mm, with a sinusoidal signal having a frequency of 1 Hz at a temperature of −10° C., is applied to the test specimen. The result of the test (NCF) is the mean of the results obtained on 10 test specimens.

The process for evaluating the fatigue strength of the polymeric compositions thus comprises the following stages:
i) providing a polymeric composition;
ii) manufacturing several notched axisymmetric test specimens from pipes or strips extruded from said composition;
iii) subjecting said test specimens to a tensile fatigue test comprising several cycles of uniaxial loading and unloading of the test specimen, inducing in the latter triaxial stresses simulating the conditions of stressing of a pipe as used in the applications targeted, and
iv) determining the number of cycles to failure for said polymeric composition.

In order to carry out a hot creep test, a tensile test is carried out according to the standard ISO 527 (test specimens of type 1A at the rate of 50 mm/min) on nonaged test specimens of the polymeric composition, with conditioning of these test specimens at the test temperature (which can, for example, be 130° C., or 150° C., or 165° C.), 20 minutes before the test. The yield stress of these test specimens corresponds to the maximum nominal stress withstood by the test specimens during the tensile testing. The higher the stress, the better the creep strength of the polymeric composition at the test temperature under consideration.

### EXAMPLE

The following example illustrates the invention without limiting it.

A composition according to the invention with the following formulation is prepared:
74% of Kynar® 401 polymer (PVDF homopolymer sold by Arkema);
19% of Kynar Ultraflex® copolymer (VDF-HFP copolymer containing between 23 and 24% by weight of HFP, origin: Arkema);
3% of dibutyl sebacate (plasticizer);
4% of TAIC.

The composition is obtained by melt blending powders or granules comprising the different polymeric compounds, and also the plasticizer and the TAIC, on a co-kneader of PR 46 type of Buss brand with a diameter of 46 millimeters, with a length 15 times its diameter and equipped with a recovery extruder, at a throughput of 10 kg/h. The rotational speed of the screw of the co-kneader is 150 rev/min and that of the recovery extruder is approximately 15 rev/min and the temperature profile is set so as to obtain an internal temperature of between 200° C. and 230° C.

The granules obtained are subsequently extruded as a strip or as a pipe with a thickness of between 6 and 10 mm using a single-screw extruder equipped with a suitable die. The temperature profile is set so as to obtain an internal temperature of between 210° C. and 250° C.

The strips and the pipes are irradiated during the extrusion under 50 kgray by a source of beta radiation, at a rate of 0.3 m/min.

1. A process for the manufacture of a composition, comprising the steps of:
blending of a polyvinylidene fluoride with a copolymer of vinylidene fluoride and a comonomer and with a crosslinking agent;
crosslinking &f the blend obtained.

2. The process as claimed in claim 1, further comprising the step of extruding said blend before it is crosslinked; or extruding said blend with at least one secondary composition before the crosslinking, the secondary composition being coextruded in the internal position with respect to said blend.

3. The process as claimed in claim 1, in which the crosslinking is obtained by irradiation of the blend.

4. The process as claimed in claim 1, in which the polyvinylidene fluoride exhibits a viscosity of 2000 to 3000 Pa·s, under 100 s⁻¹ at a temperature of 230° C., and/or in which the copolymer exhibits a viscosity of 3500 to 4500 Pa·s, under 100 s⁻¹ at a temperature of 230° C.

5. The process as claimed in claim 1, in which the composition additionally comprises a plasticizer, in a proportion by weight of 0.5 to 7%, the plasticizer being chosen from dibutyl sebacate, dioctyl phthalate, N-(n-butyl)sulfonamide, polymeric polyesters and the combinations of these.

6. The process as claimed in claim 1, in which:
the proportion by weight of the polyvinylidene fluoride in the blend is from 65 to 85%; and/or
the proportion by weight of the copolymer in the blend is from 10 to 30%; and/or
the proportion by weight of crosslinking agent is from 0.1 to 10%,
the total coming to 100%.

7. The process as claimed in claim 1, 6, in which the comonomer present in the copolymer is selected from the group consisting of vinyl fluoride, trifluoroethylene, chlorotrifluoroethylene (CTFE), 1,2-difluoroethylene, tetrafluoroethylene (TFE), hexafluoropropylene (HFP), perfluoro(alkyl vinyl) ethers, perfluoro(methyl vinyl) ether (PMVE), perfluoro(ethyl vinyl) ether (PEVE), perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H, the product of formula. CF₂═CFOCF₂CF₂SO₂F; the product of formula F(CF₂)ₙCH₂OCF═CF₂ in which n is 1, 2, 3, 4 or 5; the product of formula R1CH₂OCF═CF₂ in which R1 is hydrogen or F(CF₂)_{z} and z has the value 1, 2, 3 or 4; the product of formula R3OCF═CH₂ in which R3 is F(CF₂)_{z} and z has the value 1, 2, 3 or 4; perfluorobutylethylene (PFBE), fluorinated ethylene propylene (FEP), 3,3,3-trifluoropropene, 2-trifluoromethyl-3,3,3-trifluoro-1-propene, 2,3,3,3-tetrafluoropropene or HFO-1234yf, E-1,3,3,3-tetrafluoropropene, HFO-1234zeE, Z-1,3,3,3-tetrafiuoropropene, HFO-1234zeZ, 1,1,2,3-tetrafluoropropene, HFO-1234yc, 1,2,3,3-tetrafluoropropene or HFO-1234ye, 1,1,3,3-tetra fluoropropene, HFO-1234ze, chlorotetrafluoropropene, and HCFO-1224.

8. The process as claimed in claim 1, in which the comonomer is present in the copolymer in a proportion by weight of 20 to 40%.

9. The process as claimed in claim 1, in which the crosslinking agent is chosen from bisimides, triallyl cyanurate and triallyl isocyanurate.

10. The process as claimed in claim 1, in which said blend additionally comprises up to 10% by weight of one or more additives chosen from fibers, manufacturing additives and stabilizers.

11. A composition obtained by the process of claim 1.

12. An article comprising the composition according to claim 11.

13. The article as claimed in claim 12, wherein said article is a pipe for the transportation of products in the gas or liquid state.

14. The article as claimed in claim 13, in which the pipe is a pipe for the transportation of synthesis products selected from the group consisting of hydrogen, oxygen, steam, carbon monoxide, ammonia, hydrogen fluoride, hydrochloric acid, hydrogen sulfide, any gas resulting from the cracking of hydrocarbons, and mixtures of these.

15. The article as claimed in claim 13, in which the pipe is a pipe for the transportation of water, solvents or mixtures of these.

16. The article as claimed in claim 13, in which the pipe is an underground pipe for a service station or a fuel feed pipe for vehicles.

17. The article as claimed in claim 13, in which the pipe is an umbilical or flexible pipe for the transportation of crude oil, natural gas, water and/or other drilling products.

18. The article as claimed in claim 17, in which the pipe is a pipe for off-shore use.

19. The article as claimed in claim 12, in which the article is an electric cable.

20. (canceled)
